(19) United States
(12) Patent Application Publication
(10) Pub. No.: US 2015/0084976 A1
(43) Pub. Date: Mar. 26, 2015

(54) Display Device Settings

(71) Applicant: Microsoft Corporation, Redmond, WA (US)

(72) Inventors: Wei Guo, Sammamish, WA (US); Yi He, Issaquah, WA (US); Thitipant Tantasirikorn, Woodinville, WA (US)

(73) Assignee: Microsoft Corporation, Redmond, WA (US)

(21) Appl. No.: 14/033,506

(22) Filed: Sep. 22, 2013

(51) Int. Cl. G09G 5/00; G09G 5/02; G06F 1/16; G09G 5/10

(52) U.S. Cl. CPC G09G 5/003; G09G 5/10; G09G 5/02; G06F 1/1647
USPC 345/589; 345/581; 345/156

(57) ABSTRACT

Display device settings are described. In one or more implementations, an apparatus includes a display device and a display settings control module. The display device has a plurality of display settings, at least one of the display settings is adjustable to one of a plurality of different display setting levels. The display setting control module is implemented at least partially in hardware and configured to expose functionality having a plurality of different user selectable levels, the user selectable levels arranged in a plurality of intervals in which, user selectable levels in a corresponding said interval are successively spaced apart from each other at increasing amounts, one to another.

### BACKGROUND

Displays are incorporated in an ever increasing variety of different types of devices. From initial use in televisions to desktop computers, laptop computers and now to mobile computing devices such as tablet computers and mobile phones, displays may be utilized in a variety of different environments.

However, conventional techniques that were available to users to adjust settings of the display device were typically targeted toward adjustments that were available from the device and not how a user perceived changes to the settings. Consequently, these conventional techniques could make it difficult for a user to arrive at an optimal setting for that user, which could be both frustrating and limit a user's experience with the device.

### SUMMARY

Display device settings are described. In one or more implementations, an apparatus includes a display device and a display settings control module. The display device has a plurality of display settings, at least one of the display settings is adjustable to one of a plurality of different display setting levels. The display setting control module is implemented at least partially in hardware and configured to expose functionality having a plurality of different user selectable levels, the user selectable levels arranged in a plurality of intervals in which, user selectable levels in a corresponding said interval are successively spaced apart from each other at increasing amounts, one to another.

In one or more implementations, an apparatus includes a display device and a display settings control module. The display device has a plurality of display settings, at least one of the display settings is adjustable to one of a plurality of different display setting levels. The display setting control module is implemented at least partially in hardware and configured to expose functionality having a plurality of different user selectable levels. Each of the user selectable levels corresponds to one of the display setting levels. The user selectable levels are arranged in a plurality of intervals in which, user selectable levels in a corresponding said interval have a portion having corresponding display setting levels spaced apart from each other, successively, at increasing amounts, one to another and a portion having corresponding display setting levels spaced apart from each other, successively, at decreasing amounts, one to another.

In one or more implementations, a computing device includes an external enclosure and a display device secured by the external enclosure and configured to be viewed by a user, the display device having a plurality of display settings, at least one of the display settings adjustable to one of a plurality of different display setting levels. The computing device also includes a display settings control module implemented at least partially in hardware and disposed within the external enclosure. The display settings control module is configured to expose functionality having a plurality of different user selectable levels, each user selectable level corresponding to one of the display setting levels, the corresponding display setting levels spaced apart from each other, successively, at increasing amounts, one to another.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the techniques described herein for display device settings.

FIG. 2 is an illustration of a table showing correspondence between user setting levels and display setting levels.

FIG. 3 is an illustration of a table showing correspondence between user setting levels and display setting levels.

FIG. 4 depicts a graph plotting values of the tables of FIGS. 2 and 3.

### DETAILED DESCRIPTION

### Overview

Displays may have a variety of different types of display settings that may be adjusted by a user, such as contrast, brightness, and so on. However, conventional techniques typically involved a linear scale of adjustments that were made available based on a range of adjustment supported by the display. Consequently, these adjustments did not address how a user typically viewed the device.

Display device setting techniques are described. In one or more implementations, user selectable display settings are exposed that mimic how a user is likely to view the display. For example, a user of a display device typically views the display to have a brightness set in a low to middle range and not at a higher end of the range as this may cause objects to become difficult to view. Accordingly, user selectable levels may be configured to have a higher granularity at the low to middle ranges and less granularity at the higher ranges for this setting. A variety of other examples are also contemplated, such as to incorporate intervals, further discussion of which may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

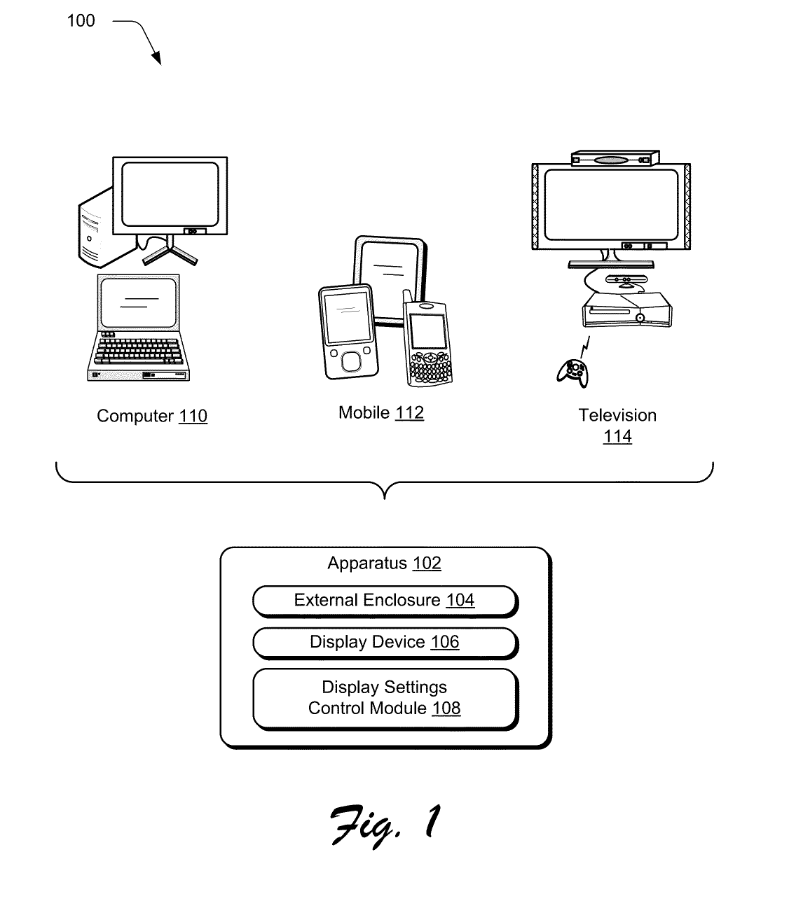

FIG. 1 is an illustration of an environment 100 in an example implementation that is operable to employ techniques described herein. The illustrated environment 100 includes an apparatus 102 that includes an external enclosure 104, a display device 106, and a display settings control module 108. The external enclosure 104 may be configured in a variety of different ways, such as for use consistent with a computer 110, mobile 112, or television 114 device class. A class of devices may be defined by physical features, types of usage, or other common characteristics of the devices.

Each of these configurations includes devices that may have generally different constructs and capabilities, and thus the apparatus 102 may be configured according to one or more of the different device classes. For instance, the computing device 102 may be implemented as the computer 110 class of a device that includes a personal computer, desktop computer, a multi-screen computer, laptop computer, netbook, and so on. The apparatus 102 may also be configured for support of such a device class, such as a stand-alone monitor.

The apparatus 102 may also be implemented as the mobile 112 class of device that includes mobile devices, such as a mobile phone, portable music player, portable gaming device, a tablet computer, a multi-screen computer, and so on. The apparatus 102 may also be implemented as the television 114 class of device that includes devices having or connected to generally larger screens in casual viewing environments. These devices include televisions, set-top boxes, gaming consoles, and so on. The techniques described herein may be supported by these various configurations of the apparatus 102 and are not limited to the specific examples the techniques described herein.

The apparatus 102 is also configured as include a display settings control module 108. The display settings control module 108 is representative of functionality to adjust one or more settings of the display device 106 for display of content. Examples of display settings include brightness, contrast, color, tint, and sharpness. As previously described, conventional techniques that were utilized to adjust the display settings typically followed a linear approach that was based on equal divisions of an available adjustment range for the setting. However, this may differ from a user's expectations in that different portions of the range may have different corresponding utility to a user. For example, settings at a top portion of the brightness range may have limited usefulness due to difficulty by a user in viewing objects displayed at this setting as well as an amount of power consumed at this setting.

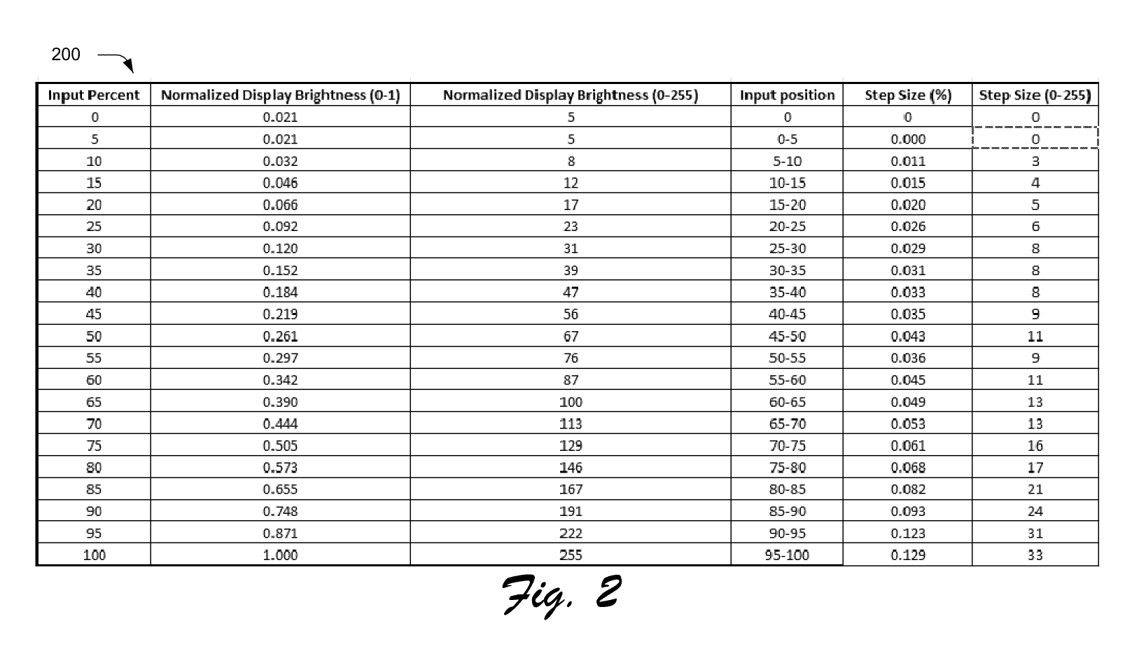

Accordingly, the display settings control module 108 may be configured to leverage nonlinear adjustment techniques. The nonlinear adjustment techniques may be configured to correspond to a user's expectations and natural usage of the display device 106. This may be performed in a variety of ways, different examples of which are shown in relation to FIGS. 2-4. Although examples involving brightness are described in the following discussion, it should be readily apparent that these examples may be equally applicable to a variety of other display settings, such as contrast, color, tint, sharpness, and so on. Accordingly, the following discussion is not to be construed as limited to brightness.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs) or other hardware. The program code can be stored in one or more computer readable memory devices. The features of the techniques described below are platform-independent, meaning that the techniques may be implemented on a variety of commercial computing platforms having a variety of processors.

For example, the apparatus 102 may also include an entity (e.g., software) that causes hardware of the apparatus 102 to perform operations, e.g., processors, functional blocks, and so on. For example, the apparatus 102 may include a computer-readable medium that may be configured to maintain instructions that cause the computing device, and more particularly hardware of the apparatus 102 to perform operations. Thus, the instructions function to configure the hardware to perform the operations and in this way result in transformation of the hardware to perform functions. The instructions may be provided by the computer-readable medium to the apparatus 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of a table 200 in an example implementation showing user selectable levels and corresponding display setting levels of the display device 106 of the apparatus 102 FIG. 1. In this example, the display device 106 supports a plurality of different display setting levels from 0 to 255, although other configurations are also contemplated.

User selectable levels are representative of levels that are exposed to a user for manual adjustment by the user, such as using a user interface output by the display device 106 (e.g., a slider control), physical buttons, and so on. The table describes the user selectable levels as an input percent, but other examples of expressing user selectable levels are also contemplated, such as input of numerical values, natural language (e.g., “high,” “low”), and so forth.

Correspondence of the user selectable levels with the display setting levels may be configured to support a nonlinear scale. As shown in the table 200, for instance, as the input position increases through the user selectable levels within an interval, a size of a step taken for corresponding display setting levels also increases, which is shown in the “step size” columns as both a percentage and a value from a 0-255 range.

For example, the following progression may be utilized for correspondence between user selectable levels and display setting levels such that the corresponding display setting levels are spaced apart from each other, successively, at increasing amounts, one to another, within an interval as follows:

User setting level: 0; Display Setting Level (0-1): 0.021, (0-255): 5;

User setting level: 5; Display Setting Level (0-1): 0.021, (0-255): 5;

User setting level: 10; Display Setting Level (0-1): 0.032, (0-255): 8;

User setting level: 15; Display Setting Level (0-1): 0.046, (0-255): 12;

User setting level: 20; Display Setting Level (0-1): 0.066, (0-255): 17;

User setting level: 25; Display Setting Level (0-1): 0.092, (0-255): 23;

User setting level: 30; Display Setting Level (0-1): 0.120, (0-255): 31;

User setting level: 35; Display Setting Level (0-1): 0.152, (0-255): 39;

User setting level: 40; Display Setting Level (0-1): 0.184, (0-255): 47;

User setting level: 45; Display Setting Level (0-1): 0.219, (0-255): 56;

User setting level: 50; Display Setting Level (0-1): 0.261, (0-255): 67;

User setting level: 55; Display Setting Level (0-1): 0.297, (0-255): 76;

User setting level: 60; Display Setting Level (0-1): 0.342, (0-255): 87;

User setting level: 65; Display Setting Level (0-1): 0.390, (0-255): 100;

User setting level: 70; Display Setting Level (0-1): 0.444, (0-255): 113;

User setting level: 75; Display Setting Level (0-1): 0.505, (0-255): 129;

User setting level: 80; Display Setting Level (0-1): 0.573, (0-255): 146;

User setting level: 85; Display Setting Level (0-1): 0.655, (0-255): 167;

User setting level: 90; Display Setting Level (0-1): 0.748, (0-255): 191;

User setting level: 95; Display Setting Level (0-1): 0.871, (0-255): 222; and

User setting level: 100; Display Setting Level (0-1): 1.000, (0-255): 255.

Thus, as shown in this example not only does the display setting level increase with the user setting level in an interval, but the amount of the display setting level also increases for each corresponding user setting level in the interval.

Individual sizes of steps based on this correspondence is described as follows which shows the increasing size of the steps involved in the correspondence between the user setting levels and the display setting levels for respective intervals:

a first interval:
User setting level: 5; Display Setting Level Step (0-1): 0, (0-255): 0;
User setting level: 10; Display Setting Level Step (0-1): 0.011, (0-255): 3;
User setting level: 15; Display Setting Level Step (0-1): 0.015, (0-255): 4;
User setting level: 20; Display Setting Level Step (0-1): 0.020, (0-255): 5;
User setting level: 25; Display Setting Level Step (0-1): 0.026, (0-255): 6; and
User setting level: 30; Display Setting Level Step (0-1): 0.029, (0-255): 8;
   a second interval:
User setting level: 40; Display Setting Level Step (0-1): 0.033, (0-255): 8;
User setting level: 45; Display Setting Level Step (0-1): 0.035, (0-255): 9; and
User setting level: 50; Display Setting Level Step (0-1): 0.043, (0-255): 11;
   a third interval:
User setting level: 55; Display Setting Level Step (0-1): 0.036, (0-255): 9;
User setting level: 60; Display Setting Level Step (0-1): 0.045, (0-255): 11; and
User setting level: 65; Display Setting Level Step (0-1): 0.049, (0-255): 13; and
   a fourth interval:
User setting level: 75; Display Setting Level Step (0-1): 0.061, (0-255): 16;
User setting level: 80; Display Setting Level Step (0-1): 0.068, (0-255): 17;
User setting level: 85; Display Setting Level Step (0-1): 0.082, (0-255): 21;
User setting level: 90; Display Setting Level Step (0-1): 0.093, (0-255): 24;
User setting level: 95; Display Setting Level Step (0-1): 0.123, (0-255): 31;
User setting level: 100; Display Setting Level Step (0-1): 0.129, (0-255): 33.

Thus, as shown above a step size generally increases within the intervals in the range for the first, second, third, and fourth intervals in this example. However, the step size does not increase between the intervals, e.g., at an approximate midpoint in the range that defines a division between the second and third intervals between input percentages of 50-55. In this way, increased granularity of user selection is supported between the intervals, such as at an approximate midpoint for corresponding display setting levels than elsewhere along the range. Further, the increase in spacing between the corresponding display setting levels also promotes increased granularity at lower levels of the display setting level range than at upper levels.

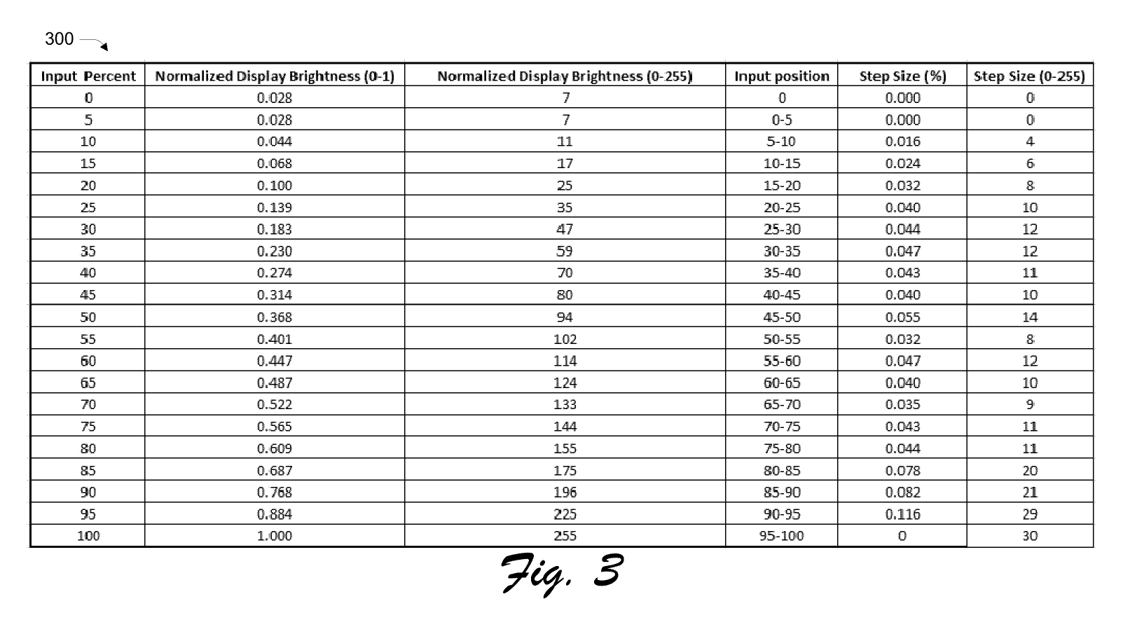

FIG. 3 is an illustration of a table 300 in an example implementation showing user selectable levels and corresponding display setting levels of the display device 106 of the apparatus 102 FIG. 1. In this example, the display device 106 supports a plurality of different display setting levels from 0 to 255, although other configurations are also contemplated as previously described.

As before, user selectable levels are representative of levels that are exposed to a user for manual adjustment by the user, such as using a user interface output by the display device 106 (e.g., a slider control), physical buttons, and so on. The table 300 describes the user selectable levels as an input percent, but other examples of expressing user selectable levels are also contemplated, such as input of numerical values, natural language (e.g., “high,” “low”), and so forth.

Correspondence of the user selectable levels with the display setting levels may be configured to support a nonlinear scale. As shown in the table 300, for instance, as the input position increases through the user selectable levels within an interval, a size of a step taken for corresponding display setting levels increases and then decreases, which is shown in the “step size” columns as both a percentage and a value from a 0-255 range.

For example, the following progression may be utilized for correspondence between user selectable levels and display setting levels. This correspondence shows that the corresponding display setting levels are spaced apart from each other, successively, at increasing and then decreasing amounts, one to another, within respective intervals as follows:

User setting level: 0; Display Setting Level (0-1): 0.028, (0-255): 7;

User setting level: 5; Display Setting Level (0-1): 0.028, (0-255): 7;

User setting level: 10; Display Setting Level (0-1): 0.044, (0-255): 11;

User setting level: 15; Display Setting Level (0-1): 0.068, (0-255): 17;

User setting level: 20; Display Setting Level (0-1): 0.0100, (0-255): 25;

User setting level: 25; Display Setting Level (0-1): 0.139, (0-255): 35;

User setting level: 30; Display Setting Level (0-1): 0.183, (0-255): 47;

User setting level: 35; Display Setting Level (0-1): 0.230, (0-255): 59;

User setting level: 40; Display Setting Level (0-1): 0.274, (0-255): 70;

User setting level: 45; Display Setting Level (0-1): 0.314, (0-255): 80;

User setting level: 50; Display Setting Level (0-1): 0.368, (0-255): 94;

User setting level: 55; Display Setting Level (0-1): 0.401, (0-255): 102;

User setting level: 60; Display Setting Level (0-1): 0.447, (0-255): 114;

User setting level: 65; Display Setting Level (0-1): 0.487, (0-255): 124;

User setting level: 70; Display Setting Level (0-1): 0.522, (0-255): 133;

User setting level: 75; Display Setting Level (0-1): 0.565, (0-255): 144;

User setting level: 80; Display Setting Level (0-1): 0.609, (0-255): 155;

User setting level: 85; Display Setting Level (0-1): 0.687, (0-255): 175;

User setting level: 90; Display Setting Level (0-1): 0.768, (0-255): 196;

User setting level: 95; Display Setting Level (0-1): 0.884, (0-255): 225; and

User setting level: 100; Display Setting Level (0-1): 1.000, (0-255): 255.

Thus, as shown in this example the display setting level continues to increase with the user setting level in an interval, however the amount of the display setting level increase changes in an amount of the increase. In other words, the size of the step increases and then decreases within an interval.

For example, the above correspondence may be expressed showing changes in step sizes for corresponding intervals as follows:

a first interval:
User setting level: 5; Display Setting Level Step (0-1): 0, (0-255): 0;
User setting level: 10; Display Setting Level Step (0-1): 0.016, (0-255): 4;
User setting level: 15; Display Setting Level Step (0-1): 0.024, (0-255): 6;
User setting level: 20; Display Setting Level Step (0-1): 0.032, (0-255): 8;
User setting level: 25; Display Setting Level Step (0-1): 0.040, (0-255): 10;
User setting level: 30; Display Setting Level Step (0-1): 0.044, (0-255): 12;
User setting level: 35; Display Setting Level Step (0-1): 0.047, (0-255): 12;
User setting level: 40; Display Setting Level Step (0-1): 0.043, (0-255): 11; and
User setting level: 45; Display Setting Level Step (0-1): 0.040, (0-255): 10;
   a second interval:
User setting level: 45; Display Setting Level Step (0-1): 0.040, (0-255): 10;
User setting level: 50; Display Setting Level Step (0-1): 0.055, (0-255): 14; and
User setting level: 55; Display Setting Level Step (0-1): 0.032, (0-255): 8; and
   a third interval:
User setting level: 55; Display Setting Level Step (0-1): 0.032, (0-255): 8;
User setting level: 60; Display Setting Level Step (0-1): 0.047, (0-255): 12; and
User setting level: 65; Display Setting Level Step (0-1): 0.040, (0-255): 10;
User setting level: 70; Display Setting Level Step (0-1): 0.035, (0-255): 9.
   Thus, the above includes three examples of intervals having increasing and decreasing step size.

A different type of interval may follow these intervals that mimics the behavior of the example of FIG. 2, which is described as follows:
User setting level: 75; Display Setting Level Step (0-1): 0.043, (0-255): 11;
User setting level: 80; Display Setting Level Step (0-1): 0.044, (0-255): 11;
User setting level: 85; Display Setting Level Step (0-1): 0.078, (0-255): 20;
User setting level: 90; Display Setting Level Step (0-1): 0.082, (0-255): 21;
User setting level: 95; Display Setting Level Step (0-1): 0.116, (0-255): 29; and
User setting level: 100; Display Setting Level Step (0-1): 0.116, (0-255): 30.

Thus, as shown above a step size increases and decreases within the first, second, and third intervals and increases solely within the different type of interval that follows these. Thus, the intervals are configured to provide increased user select ability within the interval and quick navigation between intervals.

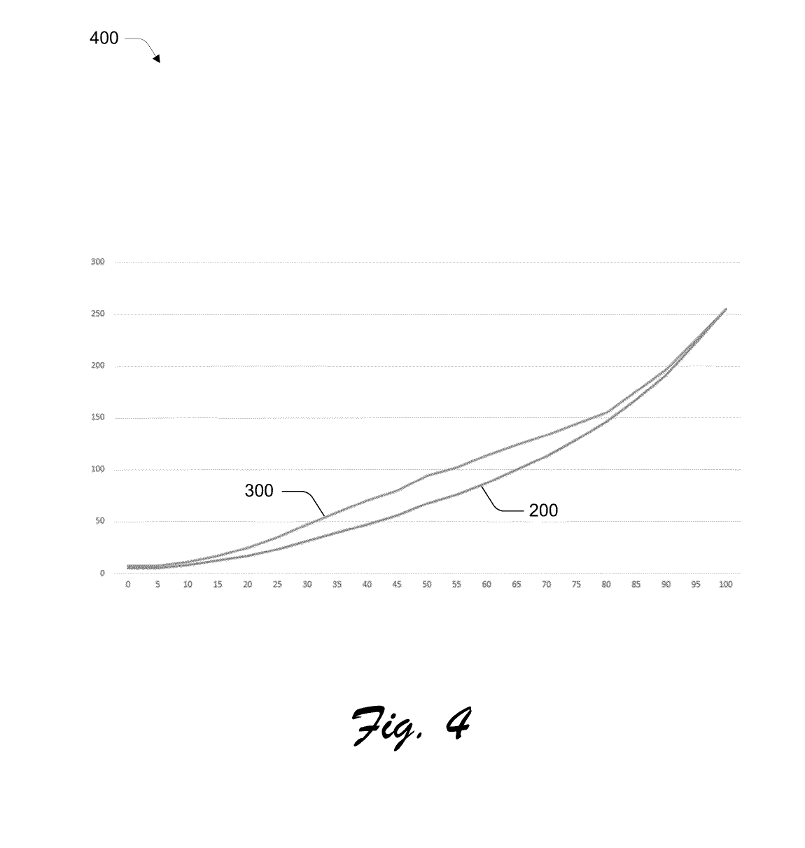

FIG. 4 is an illustration of a graph 400 that includes a plotting of the tables 200, 300 from FIGS. 2 and 3, respectively. As shown in the graph, each of the tables 200, 300 supports nonlinear adjustment of the display settings, e.g., brightness. This nonlinear adjustment provides increased granularity at lower ends of the range in comparison with higher ends of the range, although other examples are also contemplated without departing from the spirit and scope thereof.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. An apparatus comprising:
a display device having a plurality of display settings, at least one said display setting adjustable to one of a plurality of different display setting levels; and
a display settings control module implemented at least partially in hardware, the display settings control module configured to expose functionality having a plurality of different user selectable levels, the user selectable levels arranged in a plurality of intervals in which, user selectable levels in a corresponding said interval are successively spaced apart from each other at increasing amounts, one to another.

2. An apparatus as described in claim 1, wherein the at least one said display setting is brightness.

3. An apparatus as described in claim 1, wherein the at least one said display setting is contrast, color, tint, or sharpness.

4. An apparatus as described in claim 1, wherein the plurality of user selectable levels that are exposed for user selection have a lesser amount than the plurality of display setting levels available to adjust the display device.

5. An apparatus as described in claim 1, wherein the plurality of display setting levels include an amount from zero to 255 and an amount of the plurality of user selectable levels is less than that.

6. An apparatus as described in claim 1, wherein the functionality having the plurality of different user selectable levels is exposed for user selection via one or more buttons or a user interface displayed by the display device.

7. An apparatus as described in claim 1, further comprising an external enclosure configured to maintain the display device and display settings control module, the external enclosure configured as a stand-alone monitor, a mobile computing device, or a television.

8. An apparatus as described in claim 1, wherein correspondences between the user setting levels and the display setting levels approximates the following:
User setting level: 0; Display Setting Level (0-1): 0.021, (0-255): 5;
User setting level: 5; Display Setting Level (0-1): 0.021, (0-255): 5;
User setting level: 10; Display Setting Level (0-1): 0.032, (0-255): 8;
User setting level: 15; Display Setting Level (0-1): 0.046, (0-255): 12;
User setting level: 20; Display Setting Level (0-1): 0.066, (0-255): 17;
User setting level: 25; Display Setting Level (0-1): 0.092, (0-255): 23;
User setting level: 30; Display Setting Level (0-1): 0.120, (0-255): 31;
User setting level: 35; Display Setting Level (0-1): 0.152, (0-255): 39;
User setting level: 40; Display Setting Level (0-1): 0.184, (0-255): 47;
User setting level: 45; Display Setting Level (0-1): 0.219, (0-255): 56;
User setting level: 50; Display Setting Level (0-1): 0.261, (0-255): 67;
User setting level: 55; Display Setting Level (0-1): 0.297, (0-255): 76;
User setting level: 60; Display Setting Level (0-1): 0.342, (0-255): 87;
User setting level: 65; Display Setting Level (0-1): 0.390, (0-255): 100;
User setting level: 70; Display Setting Level (0-1): 0.444, (0-255): 113;
User setting level: 75; Display Setting Level (0-1): 0.505, (0-255): 129;
User setting level: 80; Display Setting Level (0-1): 0.573, (0-255): 146;
User setting level: 85; Display Setting Level (0-1): 0.655, (0-255): 167;
User setting level: 90; Display Setting Level (0-1): 0.748, (0-255): 191;
User setting level: 95; Display Setting Level (0-1): 0.871, (0-255): 222; and
User setting level: 100; Display Setting Level (0-1): 1.000, (0-255): 255.

9. An apparatus as described in claim 1, wherein the plurality of intervals include:
a first said interval:
User setting level: 5; Display Setting Level Step (0-1): 0, (0-255): 0;
User setting level: 10; Display Setting Level Step (0-1): 0.011, (0-255): 3;
User setting level: 15; Display Setting Level Step (0-1): 0.015, (0-255): 4;
User setting level: 20; Display Setting Level Step (0-1): 0.020, (0-255): 5;
User setting level: 25; Display Setting Level Step (0-1): 0.026, (0-255): 6; and
User setting level: 30; Display Setting Level Step (0-1): 0.029, (0-255): 8;
a second said interval:
User setting level: 40; Display Setting Level Step (0-1): 0.033, (0-255): 8;
User setting level: 45; Display Setting Level Step (0-1): 0.035, (0-255): 9; and
User setting level: 50; Display Setting Level Step (0-1): 0.043, (0-255): 11;
a third said interval:
User setting level: 55; Display Setting Level Step (0-1): 0.036, (0-255): 9;
User setting level: 60; Display Setting Level Step (0-1): 0.045, (0-255): 11; and
User setting level: 65; Display Setting Level Step (0-1): 0.049, (0-255): 13; or
a fourth said interval:
User setting level: 75; Display Setting Level Step (0-1): 0.061, (0-255): 16;
User setting level: 80; Display Setting Level Step (0-1): 0.068, (0-255): 17;
User setting level: 85; Display Setting Level Step (0-1): 0.082, (0-255): 21;
User setting level: 90; Display Setting Level Step (0-1): 0.093, (0-255): 24;
User setting level: 95; Display Setting Level Step (0-1): 0.123, (0-255): 31;
User setting level: 100; Display Setting Level Step (0-1): 0.129, (0-255): 33.

10. An apparatus comprising:
a display device having a plurality of display settings, at least one said display setting adjustable to one of a plurality of different display setting levels; and
a display settings control module implemented at least partially in hardware, the display settings control module configured to expose functionality having a plurality of different user selectable levels, each said user selectable level having a corresponding one of the display setting levels, the user selectable levels arranged in a plurality of intervals in which, user selectable levels in a corresponding said interval have a portion having corresponding display setting levels spaced apart from each other, successively, at increasing amounts, one to another and a portion having corresponding display setting levels spaced apart from each other, successively, at decreasing amounts, one to another.

11. An apparatus as described in claim 1, wherein the at least one said display setting is brightness.

12. An apparatus as described in claim 1, wherein the at least one said display setting is contrast, color, tint, or sharpness.

13. An apparatus as described in claim 1, wherein the plurality of user selectable levels that are exposed for user selection have a lesser amount than the plurality of display setting levels available to adjust the display device.

14. An apparatus as described in claim 1, wherein the plurality of display setting levels include an amount from zero to 255 and an amount of the plurality of user selectable levels is less than that.

15. An apparatus as described in claim 1, wherein the functionality having the plurality of different user selectable levels is exposed for user selection via one or more buttons or a user interface displayed by the display device.

16. An apparatus as described in claim 1, further comprising an external enclosure configured to maintain the display device and display setting module, the external enclosure configured as a stand-alone monitor, a mobile computing device, or a television.

17. An apparatus as described in claim 1, wherein correspondences between the user setting levels and the display setting levels approximates the following:
User setting level: 0; Display Setting Level (0-1): 0.028, (0-255): 7;
User setting level: 5; Display Setting Level (0-1): 0.028, (0-255): 7;
User setting level: 10; Display Setting Level (0-1): 0.044, (0-255): 11;
User setting level: 15; Display Setting Level (0-1): 0.068, (0-255): 17;
User setting level: 20; Display Setting Level (0-1): 0.0100, (0-255): 25;
User setting level: 25; Display Setting Level (0-1): 0.139, (0-255): 35;
User setting level: 30; Display Setting Level (0-1): 0.183, (0-255): 47;
User setting level: 35; Display Setting Level (0-1): 0.230, (0-255): 59;
User setting level: 40; Display Setting Level (0-1): 0.274, (0-255): 70;
User setting level: 45; Display Setting Level (0-1): 0.314, (0-255): 80;
User setting level: 50; Display Setting Level (0-1): 0.368, (0-255): 94;
User setting level: 55; Display Setting Level (0-1): 0.401, (0-255): 102;
User setting level: 60; Display Setting Level (0-1): 0.447, (0-255): 114;
User setting level: 65; Display Setting Level (0-1): 0.487, (0-255): 124;
User setting level: 70; Display Setting Level (0-1): 0.522, (0-255): 133;
User setting level: 75; Display Setting Level (0-1): 0.565, (0-255): 144;
User setting level: 80; Display Setting Level (0-1): 0.609, (0-255): 155;
User setting level: 85; Display Setting Level (0-1): 0.687, (0-255): 175;
User setting level: 90; Display Setting Level (0-1): 0.768, (0-255): 196;
User setting level: 95; Display Setting Level (0-1): 0.884, (0-255): 225; and
User setting level: 100; Display Setting Level (0-1): 1.000, (0-255): 255.

18. An apparatus as described in claim 1, wherein the plurality of intervals include:
a first said interval:
User setting level: 5; Display Setting Level Step (0-1): 0, (0-255): 0;
User setting level: 10; Display Setting Level Step (0-1): 0.016, (0-255): 4;
User setting level: 15; Display Setting Level Step (0-1): 0.024, (0-255): 6;
User setting level: 20; Display Setting Level Step (0-1): 0.032, (0-255): 8;
User setting level: 25; Display Setting Level Step (0-1): 0.040, (0-255): 10; and
User setting level: 30; Display Setting Level Step (0-1): 0.044, (0-255): 12;
User setting level: 35; Display Setting Level Step (0-1): 0.047, (0-255): 12;
User setting level: 40; Display Setting Level Step (0-1): 0.043, (0-255): 11; and
User setting level: 45; Display Setting Level Step (0-1): 0.040, (0-255): 10;
a second said interval:
User setting level: 45; Display Setting Level Step (0-1): 0.040, (0-255): 10;
User setting level: 50; Display Setting Level Step (0-1): 0.055, (0-255): 14; and
User setting level: 55; Display Setting Level Step (0-1): 0.032, (0-255): 8; or
a third said interval:
User setting level: 55; Display Setting Level Step (0-1): 0.032, (0-255): 8;
User setting level: 60; Display Setting Level Step (0-1): 0.047, (0-255): 12;
User setting level: 65; Display Setting Level Step (0-1): 0.040, (0-255): 10; and
User setting level: 70; Display Setting Level Step (0-1): 0.035, (0-255): 9.

19. A computing device comprising:
an external enclosure;
a display device secured by the external enclosure and configured to be viewed by a user, the display device having a plurality of display settings, at least one said display setting adjustable to one of a plurality of different display setting levels; and
a display settings control module implemented at least partially in hardware, the display settings control module configured to expose functionality having a plurality of different user selectable levels, the user selectable levels arranged in a plurality of intervals in which, user selectable levels in a corresponding said interval are successively spaced apart from each other at increasing amounts, one to another.

20. A computing device as described in claim 19, wherein the plurality of intervals include:
a first said interval:
User setting level: 5; Display Setting Level Step (0-1): 0, (0-255): 0;
User setting level: 10; Display Setting Level Step (0-1): 0.011, (0-255): 3;
User setting level: 15; Display Setting Level Step (0-1): 0.015, (0-255): 4;
User setting level: 20; Display Setting Level Step (0-1): 0.020, (0-255): 5;
User setting level: 25; Display Setting Level Step (0-1): 0.026, (0-255): 6; and
User setting level: 30; Display Setting Level Step (0-1): 0.029, (0-255): 8;
a second said interval:
User setting level: 40; Display Setting Level Step (0-1): 0.033, (0-255): 8;
User setting level: 45; Display Setting Level Step (0-1): 0.035, (0-255): 9; and
User setting level: 50; Display Setting Level Step (0-1): 0.043, (0-255): 11;
a third said interval:
User setting level: 55; Display Setting Level Step (0-1): 0.036, (0-255): 9;
User setting level: 60; Display Setting Level Step (0-1): 0.045, (0-255): 11; and
User setting level: 65; Display Setting Level Step (0-1): 0.049, (0-255): 13; or
a fourth said interval:
User setting level: 75; Display Setting Level Step (0-1): 0.061, (0-255): 16;
User setting level: 80; Display Setting Level Step (0-1): 0.068, (0-255): 17;
User setting level: 85; Display Setting Level Step (0-1): 0.082, (0-255): 21;
User setting level: 90; Display Setting Level Step (0-1): 0.093, (0-255): 24;
User setting level: 95; Display Setting Level Step (0-1): 0.123, (0-255): 31;
User setting level: 100; Display Setting Level Step (0-1): 0.129, (0-255): 33.
